(19) United States
(12) Patent Application Publication
(10) Pub. No.: US 2025/0272375 A1
(43) Pub. Date: Aug. 28, 2025

(54) Using Multi-Perspective Image Sensors for Topographical Feature Authentication

(71) Applicant: Google LLC, Mountain View, CA (US)

(72) Inventor: Dongeek Shin, San Jose, CA (US)

(73) Assignee: Google LLC, Mountain View, CA (US)

(21) Appl. No.: 18/857,556

(22) PCT Filed: Jun. 13, 2022
(86) PCT No.: PCT/US2022/072896

§ 371 Date: Oct. 17, 2024

(51) Int. Cl. G06F 21/32; G06V 10/141; G06V 40/12; G06V 40/13

(52) U.S. Cl. CPC G06F 21/32; G06V 10/141; G06V 40/1318; G06V 40/1353; G06V 40/1371

(57) ABSTRACT

This document describes systems and techniques directed at using multi-perspective image sensors for topographical feature authentication. A computing device having image sensors and a biometric authentication manager is configured to capture images representing topographical features of an object from two or more perspectives. Based on the images, the biometric authentication manager determines topographical features of the object and compares the determined topographical features to previously captured topographical features to determine whether the object and the previously imaged object are a same object. Responsive to determining that the object and the previously imaged object are the same object, the biometric authentication manager alters a permission to a resource associated with a computing device. By performing the techniques and systems described above, the biometric authentication manager is effective at repurposing image sensors as a biometric authentication scanner.

### BACKGROUND

Dedicated biometric authentication systems (e.g., face authentication systems, fingerprint authentication systems) are seamless, well-established methods for authenticating a user of a computing device (e.g., a smartphone, a laptop). These systems provide the user with secure, convenient user authentication, enabling the user to alter a permission to a resource associated with the computing device (e.g., unlocking the device, unlocking an application on the device). Implementing one of these dedicated biometric authentication systems in a computing device, however, may require specific hardware, space within a housing of the computing device, and special materials.

For example, a fingerprint authentication system utilizing an optical, under-display fingerprint scanner (UDFPS) may require a display material that changes to semi-transparent during fingerprint scanning or a transparent adhesive to bond the UDFPS to an underside of the display. In another example, to allocate space for the UDFPS within a housing of the computing device, the housing may need to be enlarged or a battery of the computing device may need to be reduced. This could compromise an intended product design (e.g., a thinness of a smartphone) for the computing device by increasing its physical size and weight, making it unwieldy for the user. This could also reduce a battery life of the computing device, making it unreliable for all-day use. As another example, a face authentication system may utilize one or more cameras, a dot matrix projector, and an infrared sensor for low-light functionality. These hardware modules may require space in a front of the housing of the computing device. If the manufacturer desires to maintain a large display, the manufacturer may allocate space above the display, increasing the size and weight of the computing device in addition to decreasing the screen-to-body ratio. Alternatively, the manufacturer may allocate space in a notch in the display, but this would sacrifice a uniform, uninterrupted display.

### SUMMARY

This document describes systems and techniques directed at using multi-perspective image sensors for topographical feature authentication. A computing device having image sensors and a biometric authentication manager is configured to capture images representing topographical features of an object from two or more perspectives. Based on the images, the biometric authentication manager determines topographical features of the object and compares the determined topographical features to previously captured topographical features to determine whether the object and the previously imaged object are a same object. Responsive to the determining that the object and the previously imaged object are the same object, the biometric authentication manager alters a permission to a resource associated with the computing device.

In aspects, a method for using multi-perspective image sensors for topographical feature authentication is disclosed. The method includes capturing one or more images, the one or more images representing topographical features of an object from two or more perspectives, the one or more images captured by one or more image sensors, the one or more image sensors having two or more image-capture perspectives. For example, the one or more image sensors may be incorporated into a back of a housing of a computing device as part of one or more cameras. The two or more image-capture perspectives may be possible by using one sensor with an appropriate pixel count and pixel pitch or two sensors physically separate from another configured to provide the two or more image-capture perspectives. The method further includes determining, based on the one or more images, the topographical features of the object. In an example, the object may be a fingertip, a palm, or another appropriate biometric identifier. The topographical features may be minutia of a fingerprint, creases in the palm, or other unique physical features of another biometric identifier. Furthermore, the method includes comparing the topographical features of the object to previously captured topographical features of a previously imaged object to provide a comparison result. The method also includes determining, based on the comparison result and to a threshold confidence, that the object and the previously imaged object are a same object. Responsive to the determining that the object and the previously imaged object are the same object, the method includes altering a permission to a resource associated with a computing device. For example, the altering the permission may include unlocking the computing device so that the user may access functions and features of an operating system of the computing device. The altering the permission may also include, assuming that the device is already in an unlocked state, unlocking a resource or application associated with the computing device.

In additional aspects, a computing device is disclosed. The computing device includes one or more image sensors, one or more processors, and memory. The memory stores instructions that, when executed by the one or more processors, cause the one or more processors to implement a biometric authentication manager responsible for repurposing the one or more image sensors as a biometric authentication scanner by performing the method described herein.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features nor threshold the scope of the claimed subject matter.

### BRIEF DESCRIPTION OF DRAWINGS

The details of one or more aspects of repurposing one or more image sensors as a fingerprint authentication scanner are described in this document with reference to the following Drawings, in which the use of same numbers in different instances may indicate similar features or components:

FIG. 1 illustrates an example implementation of an example computing device having one or more image sensors, one or more processors, memory, and a biometric authentication manager;

FIG. 2 illustrates an example implementation of the example computing device from FIG. 1, which is configured to use one or more image sensors as a biometric authentication scanner;

FIG. 3 illustrates an example implementation of the computing device from FIG. 2 in more detail;

FIG. 4 illustrates an example implementation of a Bayer color filter array;

FIG. 5 illustrates an example implementation of a dual pixel autofocus (DPAF) image sensor;

FIG. 6 illustrates an example implementation of an example computing device configured to use one or more image sensors as a biometric authentication scanner;

FIG. 7 illustrates an example operating environment of a user of the computing device from FIG. 6; and

FIG. 8 depicts a method for using image sensors as a biometric authentication scanner.

### DETAILED DESCRIPTION

### Overview

Many computing devices (e.g., smartphones, tablets, personal computers) include a dedicated biometric authentication system. The dedicated biometric authentication system may be a facial authentication system, a fingerprint authentication system, and so forth. Depending on an intended product design, a manufacturer of the computing device may choose one method of dedicated biometric authentication over another. For example, if the intended product design is a notch-less display, the manufacturer may choose to incorporate a fingerprint scanner in a front of a housing of the computing device below the notch-less display. In another example, and in addition to the notch-less display, if the intended product design is to maximize a screen-to-body ratio of the computing device, the manufacturer may choose to incorporate an optical UDFPS beneath a portion of the notch-less display.

However, the inclusion of a dedicated biometric authentication system in the computing device may require specific hardware modules, space within the housing of the computing device, and special materials. For example, a fingerprint authentication system utilizing an optical UDFPS may require a display material that changes to semi-transparent during fingerprint scanning or a transparent adhesive to bond the UDFPS to an underside of the display. As an additional example, a facial authentication system may be designed to work in low-light situations by incorporating an infrared camera module in the front of the housing of the computing device. The manufacturer may implement a dedicated biometric authentication system, like the examples mentioned above, by incorporating the necessary hardware modules or technologies from a third-party vendor. Alternatively, the manufacturer may develop first-party hardware modules or technologies to incorporate. The provided examples may increase the bill of materials for the computing device, which ultimately may increase a consumer cost of the computing device for the user. Additionally, depending on the hardware modules or technologies incorporated, an intended product design (e.g., thinness, notch-less display, all-day battery life) for the computing device may be compromised.

A compromised product design, an increased physical size and weight, a shorter battery life, or an increased consumer cost are a few examples of how including a dedicated biometric authentication system can lead to poor user experience. This document describes systems and techniques directed at using multi-perspective image sensors for topographical feature authentication, thus avoiding the compromised product design, the increased physical size and weight, the shorter battery life, or the increased consumer cost often associated with including a dedicated biometric authentication system.

The following discussion describes operating environments, techniques that may be employed in the operating environments, and example methods. Although systems and techniques for repurposing one or more image sensors as a fingerprint authentication scanner are described, it is to be understood that the subject of the appended claims is not necessarily limited to the specific features or methods described. Rather, the specific features and methods are disclosed as example implementations and reference is made to the operating environment by way of example only.

### Example Device

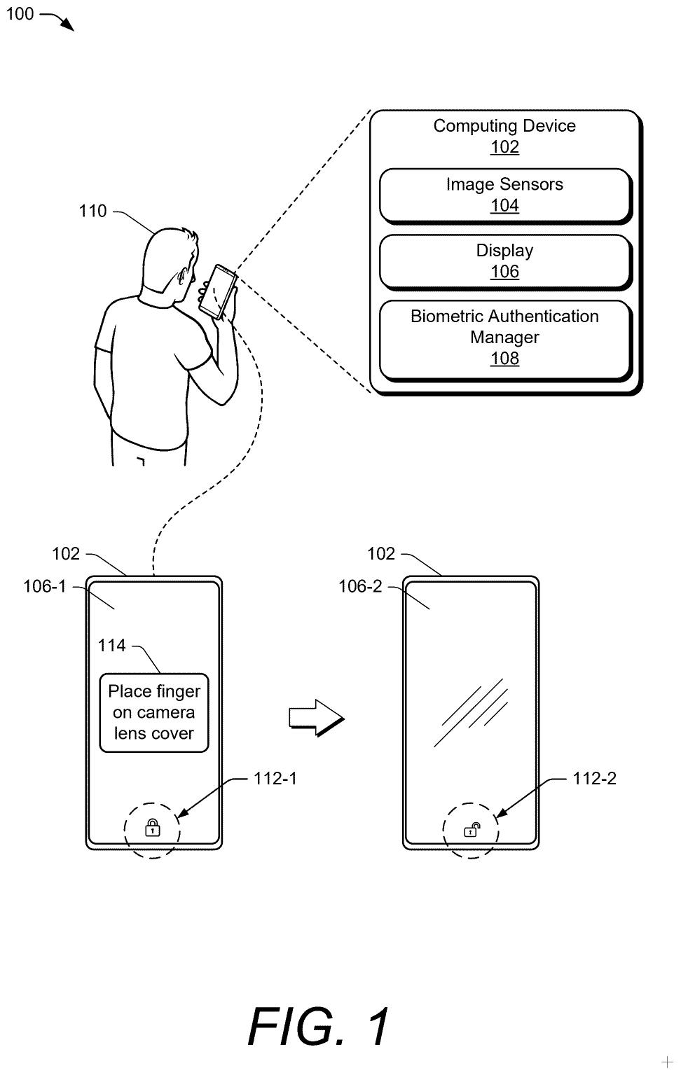

FIG. 1 illustrates an example implementation 100 of an example computing device 102 having one or more image sensors 104, a display 106, and a biometric authentication manager 108 configured to repurpose the image sensors 104 as a biometric authentication scanner. In this implementation, the computing device 102 is a budget smartphone that does not include a dedicated biometric authentication system. The image sensors 104 can be a variety of image sensors, including monochrome image sensors. Bayer filter image sensors, phase detection autofocus sensors, dual pixel autofocus sensors, and so forth. The image sensors 104 are integrated into a back of a housing of the computing device 102 as part of a camera. In front of the image sensors 104 are a camera lens assembly and a camera lens cover (e.g., glass, plastic). The display 106 is integrated as a portion of a front of the housing of the computing device 102.

In an example, a user 110 wishes to interact with the computing device 102. The user 110 picks up the computing device 102 in a locked state 112-1, as illustrated by the display 106-1. Responsive to the user 110 picking up the computing device 102 while in the locked state 112-1, the biometric authentication manager 108 displays a prompt 114 to place a finger on the camera lens cover. The user 110 places a finger on the camera lens cover, at which point the biometric authentication manager 108 instructs the camera to capture one or more images using the image sensors 104. The one or more images represent topographical features of a fingerprint of the finger, in this example, However, the object having topographical features can be any object appropriate for biometric authentication, including a palm, a thumb, and so forth. Based on the one or more images, the biometric authentication manager 108 determines the topographical features of the fingerprint. The topographical features, for example, may include minutia of ridges, valleys, and patterns of the fingerprint.

Responsive to determining the topographical features of the fingerprint, the biometric authentication manager 108 compares the topographical features to previously captured topographical features of a previously imaged object to provide a comparison result. The previously imaged object may be a same fingerprint of the user 110, for example, images of which may have been captured during an initial setup process of the computing device 102. Based on the comparison result, the biometric authentication manager 108 determines that the fingerprint of the user 110 and the previously imaged object are a same object. In an example where a threshold confidence is not met, the biometric authentication manager 108 may display an error message, detailing that the fingerprint and the previously imaged object are not the same object.

Responsive to determining that the fingerprint and the previously imaged object are the same fingerprint of the user 110, the biometric authentication manager 108 alters a permission (e.g., unlocks) to a resource (e.g., an operating system) associated with the computing device 102. By performing the method detailed above, the biometric authentication manager 108 enables a biometric authentication scanner that the user 110 may utilize to authenticate himself, altering the permission to the resource associated with the computing device 102.

Without the biometric authentication scanner enabled by the biometric authentication manager 108, for example, the user 110 may need to authenticate himself in a different manner, like inputting a password, a pin, a pattern, or another non-biometric method. These alternate manners allow for mistakes, like inputting a password incorrectly, and security concerns, like a malicious user acquiring and inputting the password correctly. In many cases, inputting a password incorrectly is a simple inconvenience for the user 110, who may simply input the password again, hopefully correctly. However, if the user 110 inputs the password incorrectly multiple times (e.g., 10 times, 20 times), depending on an operating system of the computing device 102, the operating system may prohibit the user 110 from unlocking the computing device 102 for a period of time (e.g., seconds, minutes, hours). This can be frustrating for the user 110. On the other hand, security concerns are paramount to many users of computing devices. For example, assume the user 110 had previously opened an application containing sensitive personal information (e.g., financial information, health information) using the computing device 102 and that application is still open on the computing device 102. If the malicious user acquires the computing device 102, the malicious user could acquire and use the sensitive personal information to negatively impact the user 110 (e.g., steal his identity, steal his money). Not only is this a serious concern for the user 110, but it is also another example that hurts the user's experience. However, this and other concerns are alleviated for the user 110 of the computing device 102 having the biometric authentication manager 108 configured to repurpose the one or more image sensors 104 as a biometric authentication scanner.

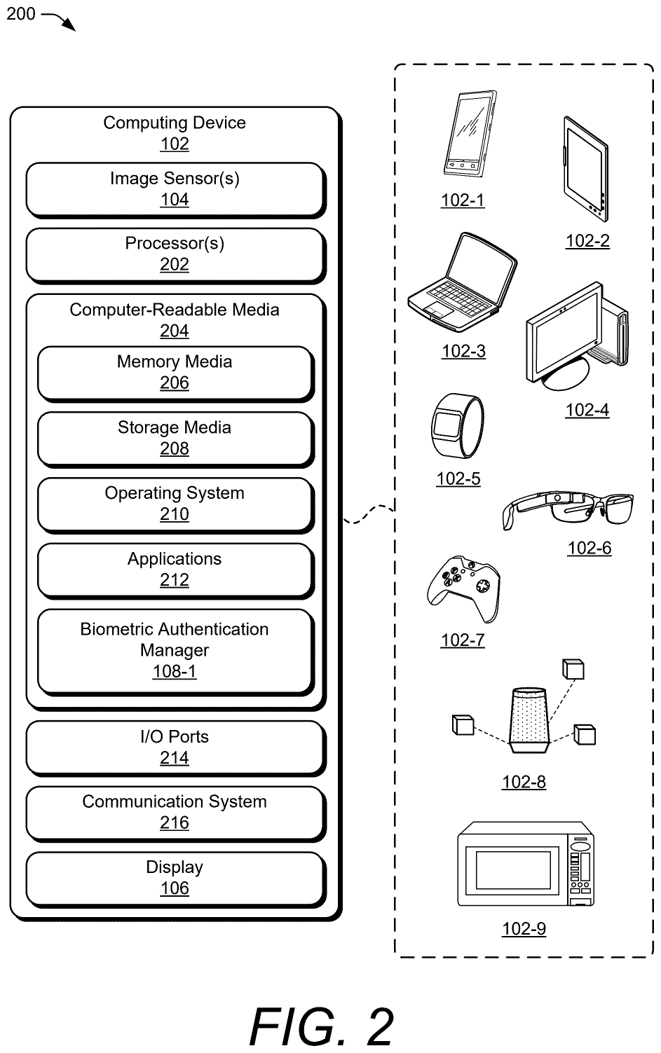

In more detail, FIG. 2 illustrates an example implementation 200 of the computing device 102 from FIG. 1, which is configured to use (e.g., repurpose existing cameras) the one or more image sensors 104 as a biometric authentication scanner. The computing device 102 is illustrated as a variety of example devices, including consumer electronic devices. As non-limiting examples, the computing device 102 can be a smartphone 102-1, a tablet 102-2, a laptop computer 102-3, a desktop all-in-one computer 102-4, a smartwatch 102-5, a pair of smart glasses 102-6, a game controller 102-7, a smart home speaker 102-8, and a microwave appliance 102-9. Although not shown, the computing device 102 can also be an automated teller machine, an audio/video recording device, a health monitoring device, a home automation system a home security system, a gaming console, a drone, a home appliance, and so forth. Note that the computing device 102 can be wearable, non-wearable but mobile, or relatively immobile (e.g., a desktop computer, a home appliance). Note also that the computing device 102 can be used with, or embedded within, many computing devices 102 or peripherals, such as in automotive vehicles or an attachment to a personal computer. The computing device 102 may include additional components and interfaces omitted from FIG. 2 for the sake of clarity or brevity.

As illustrated, the computing device 102 includes the image sensors 104, one or more processors 202, and computer-readable media 204 (CRM 204). The image sensors 104 may include one or more of any appropriate image sensor (e.g., phase detection autofocus sensor, dual pixel autofocus (DPAF) sensor, charge-coupled device sensor). The processors 202 may include one or more of any appropriate single-core or multi-core processor (e.g., central processing unit, graphics processing unit). The CRM 204 includes memory media 206 and storage media 208. An operating system 210 (OS 210), applications 212, and a biometric authentication manager 108-1 are implemented as computer-readable instructions on the CRM 204. These computer-readable instructions can be executed by the processors 202 to provide some or all the functionalities described herein. For example, the processors 202 may perform specific computational tasks of the OS 210 directed at repurposing the image sensors 104 as a biometric authentication scanner. The CRM 204 may include one or more non-transitory storage devices such as a solid-state drive, a magnetic spinning drive, random-access memory, or any type of memory media suitable for storing electronic instructions, each coupled with a data bus. The term “coupled” may refer to two or more elements that are in direct contact (physically, electrically, optically, etc.) or two or more elements that are not in direct contact with each other, but still cooperate or interact with each other.

In aspects, various implementations of the biometric authentication manager 108-1 can include one or more integrated circuits, a system-on-chip, a secure key store, hardware embedded with firmware stored on read-only memory, a printed circuit board with various hardware components, or any combination thereof. As described herein, the biometric authentication manager 108-1 may include one or more components of the computing device 102, configured to repurpose the image sensors 104 as a biometric authentication scanner. In additional aspects, the biometric authentication manager 108-1 may be implemented as the computing device 102.

As illustrated, the computing device 102 also includes input/output ports 214 (I/O 214). The I/O ports 214 enable the computing device 102 to interact with other computing devices or users through peripheral devices, transmitting any combination of digital, analog, and radio frequency signals. The I/O ports 214 may include any combination of internal or external ports, such as universal serial bus (USB) ports, audio ports, video ports, dual inline memory module card slots, peripheral component interconnect express slots, and the like. Various peripherals may be operatively coupled with the I/O ports 214, such as human input devices, external CRM, speakers, displays, or other peripherals.

The computing device 102 also includes a communication system 216, which enables communication of device data, such as received data, transmitted data, or other data as described herein, and may provide connectivity to one or more networks and other devices connected therewith. The communication system 216 may include near-field communication transceivers, wireless local area network (WLAN) radios, wireless wide area network (WWAN) radios, and infrared transceivers, for example. Data communicated over the communication system 216 may be packetized or framed, depending on a communication protocol or a standard by which the computing device 102 communicates. The communication system 216 may include wired interfaces, such as fiber-optic or Ethernet interfaces, that facilitate communication over a local network, a private network, an intranet, or the Internet. The communication system 216 may also include wireless interfaces, such as Wi-Fi and Bluetooth interfaces, that facilitate communication over a WLAN, a WWAN, or a cellular network.

Although not shown, the computing device 102 can include a system bus, an interconnect, or a data transfer system that couples with the various components within the computing device 102. The system bus, the interconnect, or the data transfer system can include any one or combination of various bus structures, such as a memory bus, a peripheral bus, a USB, and/or a local bus that utilizes any of a variety of bus architectures.

Furthermore, the computing device includes a display 106 (e.g., a touchscreen display, a liquid crystal display (LCD)). The computing device may include or utilize any one of a variety of displays, including an in-plane switching LCD, a vertical alignment LCD, an organic light-emitting diode (OLED) display, and so forth. The display may be referred to as a screen, such that content (e.g., images, videos) may be displayed on-screen.

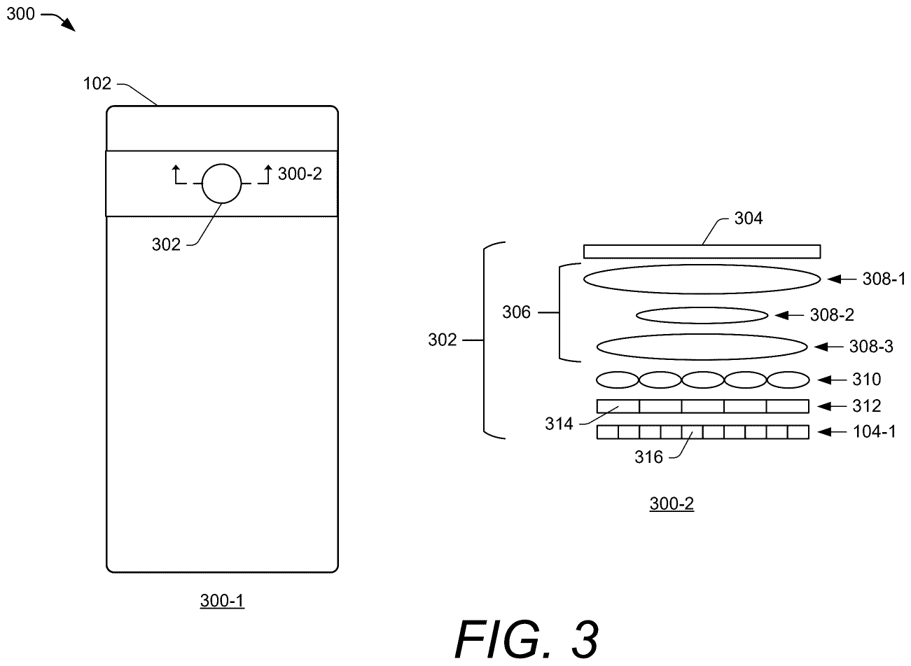

FIG. 3 illustrates an example implementation 300 of the computing device 102 having the one or more image sensors 104 in more detail. As illustrated in detail view 300-1, the computing device 102 includes a camera 302 in a back of a housing of the computing device 102. The one or more image sensors 104 are incorporated in the camera 302.

Detail view 300-2 shows a cross-sectional view of the camera 302. For clarity in the detail view, some components of the camera 302 may be omitted. As illustrated, the camera 302 comprises a transparent cover layer 304 (e.g., glass, plastic) disposed as a top layer. Disposed beneath the cover layer 304 is a lens assembly 306 consisting of multiple lenses 308. Disposed beneath the lens assembly is a micro-lens array 310. Disposed beneath the micro-lens array 310 is a color filter array 312 (CFA 312) comprising multiple color filter elements 314. Disposed beneath the CFA 312 is the one or more image sensors 104. In this example implementation 300, the one or more image sensors 104 are incorporated into the camera 302 as a single image sensor 104-1. The image sensor 104-1 comprises multiple photodiodes 316 capable of detecting intensities of the light rays, but not colors of the light rays.

Although not shown, the lens assembly 306 may include a motor operably coupled (e.g., physically, magnetically) with one or more of the lenses 308. The motor may displace one or more of the lenses 308 to appropriately focus light rays onto the image sensor 104-1 as part of an autofocus system, for example. The lens assembly 306 and the micro-lens array 310 focus light rays onto photosensitive areas of the image sensor 104-1. Depending on an application of the camera 302, the CFA 312 may be one of a variety of appropriate CFAs, including a red-yellow-yellow-blue CFA, a cyan-yellow-yellow-magenta CFA, a Bayer CFA, and so forth. The CFA 312 filters the intensities of the light rays by wavelength range, such that the separate filtered intensities detected by the photodiodes 316 include color information.

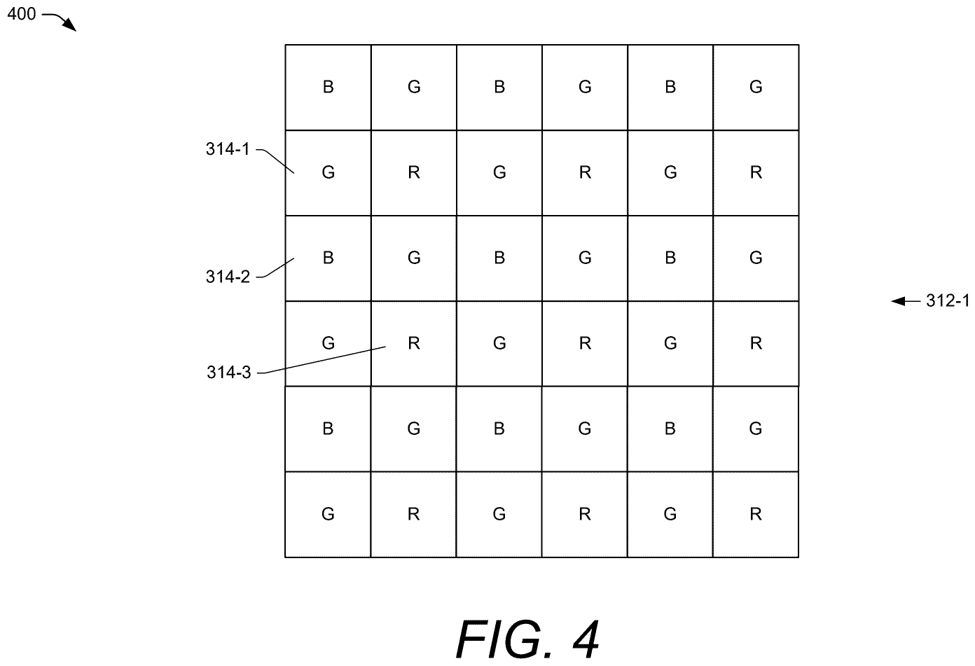

FIG. 4 illustrates an example implementation 400 of the CFA 312 from FIG. 3 implemented as a Bayer CFA 312-1. As illustrated in a top-down view, the Bayer CFA 312-1 is a six-by-six square grid of square color filter elements 314. Although a square grid of square color filter elements is shown, the shape of the grid and the shape of the color filter elements 314 may be any appropriate shape (e.g., rectangle). Additionally, the dimension of the square grid may be any appropriate dimension (e.g., 1,000-by-1,000, 1,920-by-1,080). Also as illustrated, the color filter elements 314 may be one of three different color filter elements 314 effective at filtering the intensities of the light rays by wavelength range. In this example, the color filter elements 314 are divided into green color filter elements 314-1, blue color filter elements 314-2, and red color filter elements 314-3. Each two-by-two grid of color filter elements 314 comprises two green color filter elements 314-1, one blue color filter element 314-2, and one red color filter element 314-3. This two-by-two grid, outlined in bold, may be known as a pixel 402.

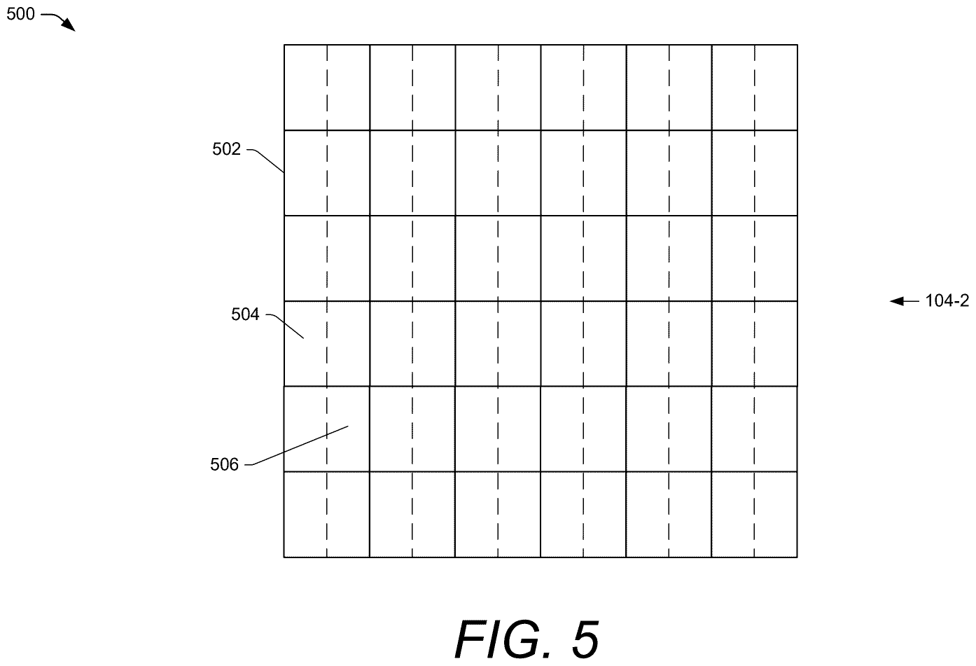

FIG. 5 illustrates an example implementation 500 of the image sensor 104-1 from FIG. 3 implemented as a dual pixel autofocus sensor 104-2 (DPAF sensor 104-2). As illustrated in a top-down view, the DPAF sensor 104-2 consists of an array of dual pixels 502, each of which is indicated by a square in solid outline. The array of dual pixels 502 is arranged into a six-by-six square grid. Although a six-by-six square grid is shown, the grid of dual pixels 502 may be any suitable dimension (e.g., 1,000-by-1,000) and shape (e.g., a rectangle). As illustrated, the dual pixel 502 is split into a left photodiode 504 and a right photodiode 506.

In a traditional application of the DPAF sensor 104-1, light rays are focused onto the left photodiode 504 and the right photodiode 506 by the micro-lens array 310. Before an image of an object is captured, a difference in photodiode amplitudes between the left photodiode 504 and the right photodiode 408 is calculated. The difference in the photodiode amplitudes may be called a phase of the dual pixel 502. If the phase is not equal or close to zero within a threshold confidence, one or more of the lenses 308 operably coupled with a motor, for example, may be positioned by the motor until the phase is equal or close to zero within the threshold confidence. Once the phase is equal or close to zero within the threshold confidence, the object of the image is in focus. Upon capturing the image of the object, the photodiode amplitudes of the left photodiode 504 and the right photodiode 506 are combined to record a full dual pixel.

However, the systems and techniques directed at using multi-perspective image sensors for topographical feature authentication described herein take the opposite approach. By positioning (e.g., by a motor) one or more lenses 308 so that the object of the image is out of focus, the phase of the dual pixel 502 is altered (e.g., maximized). This document now turns to an example operating environment in which the maximized phase is used to enable the repurposing of the DPAF sensor 104-2 as a biometric authentication scanner.

### Example Operating Environment

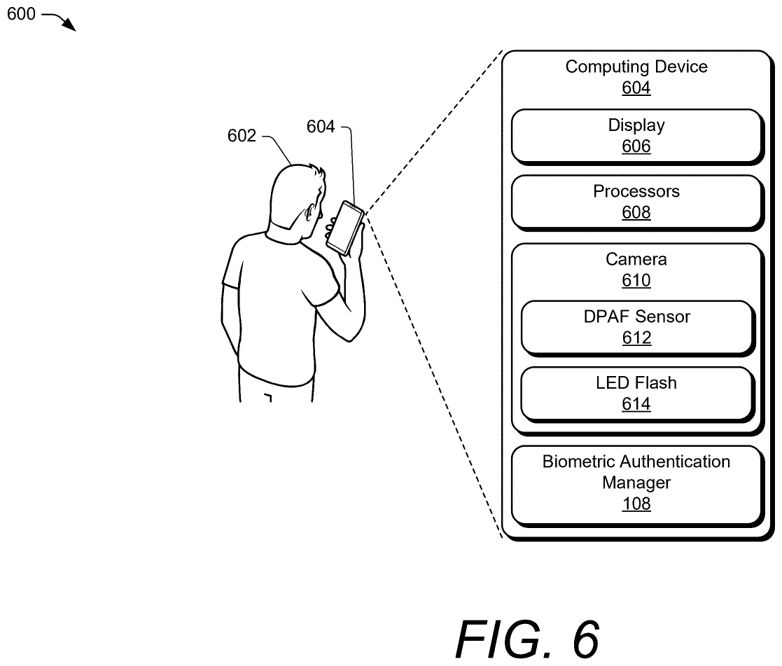

FIG. 6 illustrates an example implementation 600 of a user 602 of a computing device 604. The computing device 604 includes a display 606, processors 608, a camera 610, and the biometric authentication manager 108 configured to use one or more image sensors as a biometric authentication scanner. The camera 610 includes a DPAF sensor 612 and an LED flash 614.

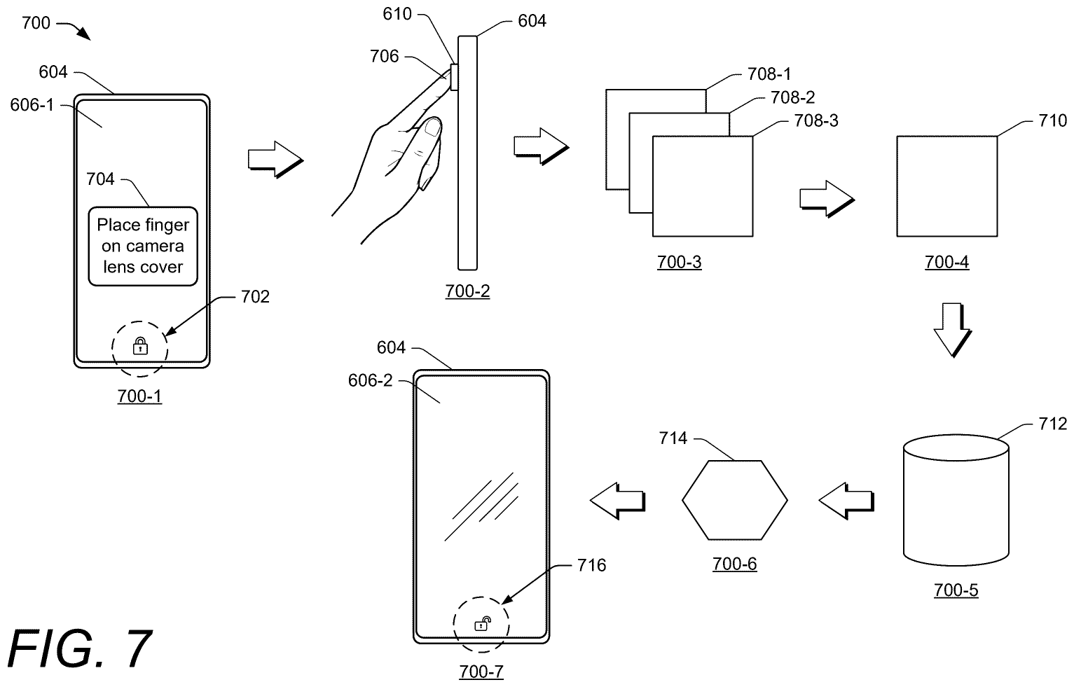

FIG. 7 illustrates an example operating environment 700 of the user 602 of the computing device 604. In this example, the user 602 picks up the computing device 604 in a locked state 702, as indicated by the display 606-1. At 700-1, responsive to the user 602 picking up the computing device 604 and tapping the display 606-1, the biometric authentication manager 108 displays a prompt 704 to the user 602 to apply user input to a cover layer of the camera 610. At 700-2, the biometric authentication manager 108 may recognize the user input, a fingertip 706 having a fingerprint in this example, by a proximity sensor, or another appropriate sensor, of the computing device 604. In another example, the biometric authentication manager 108 may recognize the fingertip 706 by determining (e.g., by light levels) that the camera 610 is being occluded by the fingertip 706. Also at 700-2, responsive to determining that the fingertip 706 is occluding the camera 610, the biometric authentication manager 108 may direct the camera 610 to achieve (e.g., by positioning one or more lenses via motor) a focus distance corresponding to an image which is out of focus, For example, the focus distance may be adjusted to infinity while the object of the image, the fingertip 706, is resting on the cover layer of the camera 610 at less than one centimeter. By so doing, the phase of each dual pixel 502 in the DPAF sensor 612 may be maximized.

Further at 700-2, the biometric authentication manager 108 may direct the camera 610 to activate the LED flash 614 to illuminate the fingertip 706 to increase the signal-to-noise ratio. In some examples, the LED flash 614 may be positioned in the camera 610 such that the fingertip 706 is illuminated at a direction sufficient to alter or emphasize features of the fingerprint from a first perspective to a greater amount than that of a second perspective, facilitating their identification. In this example, the first perspective and the second perspective are observed by the left photodiode 504 and the right photodiode 506, respectively, of each dual pixel 502 of the DPAF sensor 612. The altering or emphasizing of the features of the fingerprint may enable a greater resolution of those features.

Also at 700-2, rather than combining the photodiode amplitudes of the left and right photodiodes of each dual pixel 502, the biometric authentication manager 108 may direct the camera 610 to capture two image data of the fingerprint, one datum from the left photodiode 504 and one datum from the right photodiode 506. At 700-3, the biometric authentication manager 108 may direct the processors 608 to calculate a disparity map, which records the phase of each dual pixel photodiode pair from the image data captured at 700-2. The biometric authentication manager 108 may input the disparity map to a custom normalizer function to generate an embedding 708 (e.g., embedding 708-1), or other appropriate representation (e.g., a hash code, a string of numbers) of the image data, that does not include any visual information. At 700-4, a final embedding 710 of the fingerprint of the user 602 may be generated in multiple steps, compressing at each step the image data captured at 700-2 and 700-3.

At 700-5, the biometric authentication manager 108 may direct the processors 202 to compare the final embedding 710 of the fingerprint to a library of embeddings 712. During an initial setup process of the computing device 604, the biometric authentication manager 108 may generate the library of embeddings 712 by prompting the user 602 to scan a fingerprint multiple times at slightly different positions, computing a final embedding for each scan, and storing the final embeddings on a memory of the computing device 604. At 700-6, responsive to the comparison, the biometric authentication manager 108 may provide a comparison result 714. The biometric authentication manager 108 may determine, based on the comparison result 714 and to a threshold confidence, that the final embedding 710 of the fingerprint and the fingerprint used to generate the library of embeddings 712 are a same fingerprint. At 700-7, responsive to the determining that the final embedding 710 of the fingerprint and the library of embeddings 712 of the fingerprint are of the same fingerprint, the biometric authentication manager 108 transitions the computing device from the locked state 702 to an unlocked state 716, shown by the display 606-2.

In implementations, the computing device 604 may be in the unlocked state 716, but a high-rights resource (e.g., a financial application) of the computing device 604, requiring access permission, may be in a locked state. In such implementations, the biometric authentication manager 108 may perform the operations described herein to unlock the high-rights resource. In other implementations, the computing device 604 may be in the unlocked state, the high-rights resource may be in the locked state, and the computing device 604 may include a dedicated biometric authentication system, like a fingerprint scanner on a front face of the computing device 604. The high-rights resource, in these implementations, may require two-factor authentication (2FA) to be unlocked. The biometric authentication manager 108 may perform the operations described herein as one of two factors of the 2FA, the other factor being the fingerprint scanner on the front face of the computing device 604, for example. Optionally, or additionally, the biometric authentication manager 108 may perform the described operations contemporaneously with a scanning of a second finger by the fingerprint scanner on the front face of the computing device 604. In another implementation, the computing device 604 may be in a locked state, require 2FA to be unlocked from the locked state, and include a dedicated biometric authentication system, like a face scanner on a front face of the computing device 604. The biometric authentication manager 108 may perform the operations described herein as one of two factors of the 2FA, the other factor being the face scanner on the front face of the computing device 604. The biometric authentication manager 108 may perform the operations contemporaneously or sequentially, for example, with a scanning of a face by the face scanner on the front face of the computing device 604. Although a face scanner on a front face of the computing device 604 is described, the dedicated biometric authentication system can be any appropriate system (e.g., UDFPS, capacitive fingerprint scanner, optical face scanner) on any appropriate face (e.g., a front face, a back face) of the computing device 604. For example, the biometric authentication manager 108 may perform the method described herein using a front-facing or rear-facing camera as one of two factors of the 2FA. Meanwhile a dedicated, capacitive fingerprint scanner on an opposite, or a same, face of the computing device 604 may scan a different fingertip of a user as the other factor of the 2FA.

Although a single DPAF sensor was described, any one or more of an appropriate image sensor configured to provide two or more image capture perspectives may be utilized. For example, two image sensors physically separate from one another and are configured to provide the two or more image capture perspectives that may be utilized. In another example, a single, non-DPAF image sensor configured to provide the two or more image capture perspectives may be utilized.

### Example Methods

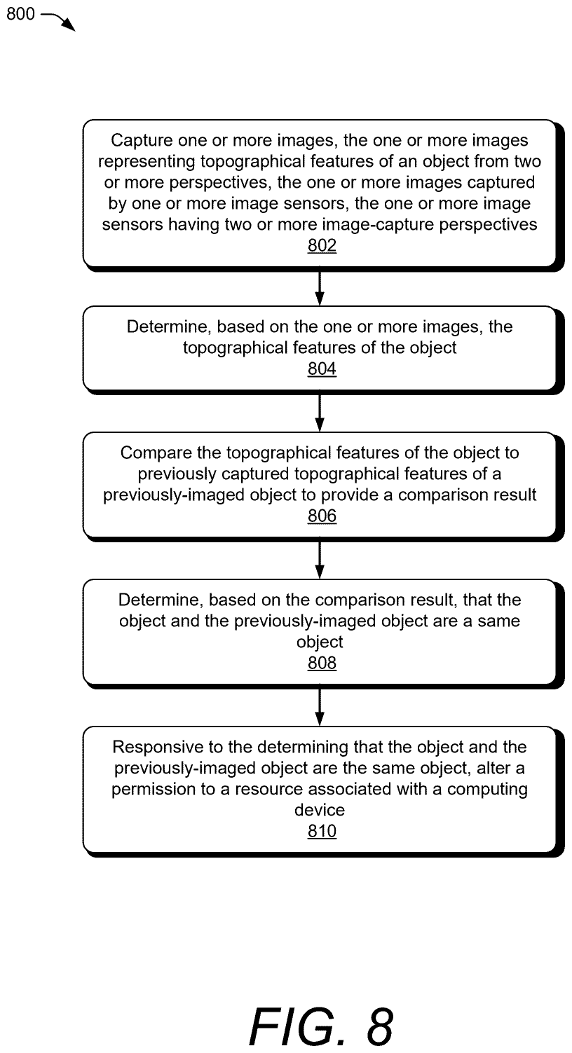

FIG. 8 outlines method 800, which enables use of image sensors as a biometric authentication scanner. The method is shown as sets of blocks that specify operations performed. The method is not necessarily limited to the order or combinations of the sets of blocks shown for performing the operations by the respective blocks. Furthermore, any one or more of the operations may be repeated, combined, reorganized, or linked to provide a plethora of additional or alternate methods. In portions of the following discussion, reference may be made to the example implementation of FIG. 1 and entities detailed in FIGS. 2 through 7, reference to which is made for example only. The techniques are not limited to performance by one entity or multiple entities operating on one computing device.

At 802, a biometric authentication manager receives or captures one or more images, the one or more images representing topographical features of an object from two or more perspectives, the one or more images captured by one or more image sensors, the one or more image sensors having two or more image-capture perspectives. For example, the object may be a fingertip of a user and the image sensors may be one or more cameras (e.g., zooming cameras, macrophotography cameras, telephotography cameras, slow motion cameras) incorporated into a back of a housing of a computing device. The cameras may be cameras with two or more image-capture perspectives. The cameras with two or more image-capture perspectives may be configured to perform the method described herein. Alternatively, the cameras with two or more image-capture perspectives may be repurposed (e.g., cameras intended for general photography, cameras intended for telephotography) to perform the method described herein. In implementations, the biometric authentication manager may capture images with, or receive images from, the one or more cameras with the two or more image-capture perspectives.

At 804, the biometric authentication manager determines, based on the one or more images, the topographical features of the object. As an example, the topographical features may be minutia (e.g., ridges, valleys, patterns) of a fingerprint of the fingertip of the user.

At 806, the biometric authentication manager compares the topographical features of the object to previously captured topographical features of a previously imaged object to provide a comparison result. For example, the previously imaged object may be the fingertip of the user. The previously captured topographical features, therefore, may be the minutia of the fingerprint. The comparison result may be based on a correlation of general patterns (e.g., loops, whorls, arches), ridge characteristics (e.g., endings, bifurcations, bridges), and other appropriate minutia points between the current fingerprint image and the previously captured fingerprint images. The current and previously captured fingerprint images, for example, can be decomposed into weighted sums of polar shapelet-base functions, where the fingerprint images are separated into components with rotational symmetries. The comparison result may also be based on a correlation between the current and the previously captured fingerprint images of these components with rotational symmetries.

At 808, the biometric authentication manager determines, based on the comparison result from 806, that the object and the previously imaged object are a same object. The biometric authentication manager may do so to a threshold confidence, for example, which may be a value (e.g., 90%, 95%) representing a similarity between the previously imaged fingertip and the current fingertip. Alternatively, the biometric authentication manager may determine that the object and the previously imaged object are the same object within a margin of error. The margin of error may be a value (e.g., 10%, 5%) representing a difference between the previously imaged fingertip and the current fingertip.

At 810, responsive to the determining that the object and the previously imaged object are the same object, the biometric authentication manager alters a permission to a resource associated with a computing device. The resource associated with the computing device could be an operating system of the computing device. In that example, the altering the permission could be unlocking the computing device, so a user may access and enjoy features of the operating system.

### Additional Examples

In the following section, additional examples are provided.

Example 1: A method comprising: capturing one or more images, the one or more images representing topographical features of an object from two or more perspectives, the one or more images captured by one or more image sensors, the one or more image sensors having two or more image-capture perspectives; determining, based on the one or more images, the topographical features of the object; comparing the topographical features of the object to previously captured topographical features of a previously imaged object to provide a comparison result; determining, based on the comparison result and to a threshold confidence, that the object and the previously imaged object are a same object; and responsive to the determining that the object and the previously imaged object are the same object, altering a permission to a resource associated with a computing device.

Example 2: The method as described in example 1, wherein: the object having topographical features is a fingertip of a user; and the previously imaged object is the fingertip of the user.

Example 3: The method as described in any one of the previous examples, wherein the one or more image sensors are on a back of the computing device.

Example 4: The method as described in example 3, wherein the one or more images sensors are one or more cameras of the computing device, and further comprising, prior to capturing the one or more images, displaying a prompt to place a finger on a camera lens cover, the camera lens cover covering a front of the one or more image sensors.

Example 5: The method as described in any one of the previous examples, wherein the method is performed responsive to the computing device being in an unlocked state but the resource of the computing device being in a locked state, and wherein altering the permission to the resource unlocks the resource associated with the computing device.

Example 6: The method as described in example 5, wherein the resource is a financial account or other high-rights resource requiring two-factor authentication and the method provides, through the determining that the object and the previously imaged object are the same object, one of two factors of the two-factor authentication.

Example 7: The method as described in example 6, wherein another of the two factors of the two-factor authentication is a prior authentication to unlock the computing device.

Example 8: The method as described in example 6, wherein another of the two factors of the two-factor authentication is a contemporaneous finger-print authentication performed on a different side of the computing device as a side on which the capturing one or more images is performed.

Example 9: The method as described in any one of the previous examples, wherein the one or more images are received from an image capture device having one dual-pixel image sensor configured to provide the two or more image capture perspectives.

Example 10: The method as described in any one of the previous examples, wherein the one or more images are received from an image capture device having at least two image sensors configured to provide the two or more image capture perspectives, the at least two image sensors physically separate one from another.

Example 11: The method as described in any one of the previous examples, wherein determining the topographical features of the object generates an embedding, the embedding being a numerical representation of the topographical features of the object.

Example 12: The method as described in example 11, wherein comparing the topographical features compares the embedding to a previously generated embedding, the previously generated embedding being a numerical representation of the previously captured topographical features of the previously imaged object.

Example 13: The method as described in any one of the previous examples, further comprising, prior to capturing the one or more images, determining that the object having the topographical features is occluding the one or more images sensors.

Example 14: The method as described in example 13, further comprising, responsive to determining that the object having topographical features is occluding the one or more images sensors and prior to or incident with capturing the one or more images, illuminating the object.

Example 15: The method as described in example 14, wherein illuminating the object is performed at a direction sufficient to alter features from one of the two or more perspectives to a greater amount than another of the two or more perspectives, the alteration of the features enabling greater resolution of the topographical features of the object.

Example 16: The method as described in any one of the previous examples, wherein the topographical features are minutia of a fingerprint.

Example 17: A computing device comprising: one or more image sensors; one or more processors; and memory storing: instructions that, when executed by the one or more processors, cause the one or more processors to implement a biometric authentication manager to provide biometric authentication utilizing the one or more image sensors by performing the method of any one of the preceding examples.

Example 18: A computer-readable medium comprising instructions that, when executed by one or more processors, cause the one or more processors to carry out the method of any one of examples 1 to 16.

### CONCLUSION

Throughout this discussion, an example is described where a biometric authentication manager of a computing device (e.g., a smartphone) analyzes information (e.g., fingerprint image data) associated with a user. Further to the description above, a user may be provided with controls allowing the user to make an election as to both if and when systems, programs, and/or features described herein may enable collection of information (e.g., fingerprint image data). The biometric authentication manager may be configured to only use the information after receiving explicit permission from the user of the computing device to use the data. For example, in situations where the biometric authentication manager may analyze image data for fingerprint features to authenticate the user, individual users may be provided with an opportunity to provide input to control whether programs or features of the computing device can collect and make use of the data. Further, individual users may have constant control over what programs can or cannot do with the information. In addition, information collected may be pre-treated in one or more ways before it is transferred, stored, or otherwise used, so that personally identifiable information is removed. As described above, the raw image data of a user's fingerprint may be transformed (e.g., compressed) into an embedding (e.g., a string of numbers) that does not contain any personally identifiable information before it is stored on the CRM of the computing device, for example. Thus, the user may have control over whether information is collected about the user and the computing device of the user, and how such information, if collected, may be used by the biometric authentication manager, the computing device, and/or a remote computing system.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques of, and apparatuses enabling, repurposing one or more existing image sensors as a biometric authentication scanner have been described in language specific to certain features and/or methods, the subject of the appended Claims is not necessarily limited to the specific features or methods described. Rather, the specific features and methods are disclosed as example implementations of repurposing one or more existing image sensors as a fingerprint authentication scanner.

1. A method comprising:
capturing one or more images, the one or more images representing topographical features of an object from two or more perspectives, the one or more images captured by one or more image sensors, the one or more image sensors having two or more image-capture perspectives;
determining, based on the one or more images, the topographical features of the object;
comparing the topographical features of the object to previously captured topographical features of a previously imaged object to provide a comparison result;
determining, based on the comparison result, that the object and the previously imaged object are a same object; and
responsive to the determining that the object and the previously imaged object are the same object, altering a permission to a resource associated with a computing device.

2. The method as described in claim 1, wherein:
the object having topographical features is a fingertip of a user; and
the previously imaged object is the fingertip of the user.

3. The method as described in claim 1, wherein the one or more image sensors are on a back of a computing device and the one or more image sensors are one or more cameras of the computing device.

4. The method as described in claim 1, wherein the method is performed responsive to the computing device being in an unlocked state but the resource associated with the computing device being in a locked state.

5. The method as claimed in claim 4, wherein the resource associated with the computing device is at least one of a financial account or other high-rights resource requiring two-factor authentication, and the method further comprises:
providing, through the determining that the object and the previously imaged object are the same object, one of two factors of the two-factor authentication.

6. The method as claimed in claim 5, wherein another of the two factors of the two-factor authentication is a contemporaneous finger-print authentication performed on a different side of the computing device as a side on which the capturing one or more images is performed.

7. The method as described in claim 1, wherein the one or more images are received from an image capture device having one dual-pixel image sensor configured to provide the two or more image capture perspectives.

8. The method as described in claim 1, wherein the one or more images are received from an image capture device having at least two image sensors configured to provide the two or more image capture perspectives.

9. The method as described in claim 1, wherein determining the topographical features of the object further comprises:
generating an embedding, the embedding being a numerical representation of the topographical features of the object.

10. The method as described in claim 9, wherein comparing the topographical features of the object to previously captured topographical features of the previously imaged object to provide a comparison result further comprises:
comparing the embedding to a previously generated embedding, the previously generated embedding being a numerical representation of the previously captured topographical features of the previously imaged object.

11. The method as described in claim 1, further comprising, prior to capturing the one or more images, determining that the object having the topographical features is occluding the one or more image sensors.

12. The method as described in claim 11, further comprising, responsive to determining that the object having topographical features is occluding the one or more images sensors and prior to or incident with capturing the one or more images, illuminating the object.

13. The method as described in claim 12, wherein illuminating the object is performed at a direction sufficient to alter features from one of the two or more perspectives to a greater amount than another of the two or more perspectives.

14. A computing device comprising:
one or more image sensors;
one or more processors; and
memory storing:
instructions that, when executed by the one or more processors, cause the one or more processors to execute operations comprising:
capture one or more images, the one or more images representing topographical features of an object from two or more perspectives, the one or more images captured by one or more image sensors, the one or more image sensors having two or more image-capture perspectives;
determine, based on the one or more images, the topographical features of the object;
compare the topographical features of the object to previously captured topographical features of a previously imaged object to provide a comparison result;
determine, based on the comparison result, that the object and the previously imaged object are a same object; and
responsive to the determination that the object and the previously imaged object are the same object, alter a permission to a resource associated with a computing device.

15. A computer-readable medium comprising instructions that, when executed by one or more processors, further configure the one or more processors to:
capture one or more images, the one or more images representing topographical features of an object from two or more perspectives, the one or more images captured by one or more image sensors, the one or more image sensors having two or more image-capture perspectives;
determine, based on the one or more images, the topographical features of the object;
compare the topographical features of the object to previously captured topographical features of a previously imaged object to provide a comparison result;
determine, based on the comparison result, that the object and the previously imaged object are a same object; and
responsive to the determination that the object and the previously imaged object are the same object, alter a permission to a resource associated with a computing device.

16. The method as described in claim 3, wherein the one or more cameras of the computing device are repurposed to image the object out of focus.

17. The method as described in claim 3, further comprising:
prior to capturing the one or more images, displaying a prompt to place a finger on a camera lens cover, the camera lens cover covering a front of the one or more image sensors.

18. The method as described in claim 4, wherein altering the permission to the resource unlocks the resource associated with the computing device.

19. The method as described in claim 8, wherein the at least two image sensors are physically separate one from another.

20. The method as described in claim 13, wherein the alteration of the features enables greater resolution of the topographical features of the object.
